(19) United States
(12) Patent Application Publication
(10) Pub. No.: US 2005/0024665 A1
(43) Pub. Date: Feb. 3, 2005

(54) System and method for dynamically controlling access to configuration attributes for a printing device

(76) Inventors: Jennifer Melin, Boise, ID (US); Honee Mesa, Eagle, ID (US); Kristin Smith, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/633,076

(22) Filed: Aug. 1, 2003

(51) Int. Cl. G06F 15/00

(52) U.S. Cl. 358/1.13

(57) ABSTRACT

A method and system is provided for dynamically controlling access to configuration attributes for a printing device. The method includes the operation of receiving a request for the printing device's configuration attributes at the printing device. The request is received from a requesting device. Another operation in determining a printing device's configuration attributes involves making a run-time determination of configuration attributes supported by the printing device. Once the configuration attributes supported by the printing device are determined, markup language code associated with these configuration attributes can be identified. Further, the present invention includes the operation of transmitting the markup language code that is associated with the configuration attributes supported by the printing device to the requesting device.

### FIELD OF THE INVENTION

The present invention relates generally to configuration attributes for a printing device.

### BACKGROUND OF THE INVENTION

A variety of different methods can be implemented to allow a user to access the configuration attributes of a printer. Some printing devices come with built-in physical interface panels, such as an LCD panel. Other printing devices are designed with a serial or parallel port that allows a user to access a printing device's configuration attributes using an external computer. Still other printing devices can have embedded web servers that enable users to view and edit the printing device's configuration attributes from any external computer with a web browser and a connection to the Internet. Among these options, the methods that provide access to a printing device's configuration attributes through an external computer are beneficial in terms of flexibility and compatibility.

As previously mentioned, a printing device can be coupled to an external computer through a serial or parallel port. In this configuration, the external computer may have a device driver that requests and displays the printing device's configuration attributes. The printing device can include an internal processing system that receives the requests and returns the data to be displayed. In many printing devices, the internal processing system contains low-level language programming code that describes the device's configuration attributes.

Another method for communicating with a printing device by way of an external computer is through an embedded web server. An embedded web server can reside with the printing device and store the configuration attributes of the printing device in the form of markup language code. Embedded web servers allow a user to access the markup language code using a browser through a network connection. Such a network can include a local area network, a wide area network, and/or the Internet. One common network service that uses the Internet to exchange information is known as the World Wide Web. Markup language code can be stored in the embedded web server of a printing device and accessed through an external computer on the same network or on the World Wide Web.

Using markup language code to describe a printing device's configuration attributes offers benefits as compared to using other types of low-level language code to describe these configuration attributes. For example, the developer's task of creating an interface for the printing device is simplified because of the abundance of powerful tools available for developing and maintaining documents built with markup language code. Flexibility is also provided to a printing device user because the user can access the printing device's configuration attributes through any computer with a browser and a network connection to the printing device.

Despite these advantages, a separate set of code that describes configuration attributes is developed for each distinct printing device whether the developer uses markup language code or some other type of low-level language code. This means that companies who sell more than one version of a printing device or multiple models of a printing device create a separate set of markup language code for every version and model. To be integrated into the printing device, the markup language code can be part of a firmware build for that device or the markup language code can be loaded from some other type of non-volatile storage device. Each markup language code build generally goes through the design and verification stages of development. Once the custom build has been created for a specific series, model, or version of a printing device, the markup language code for that build can be loaded onto the printing device. Going through this process for every separate device and model consumes valuable engineering time and increases the cost of the final product.

### SUMMARY OF THE INVENTION

The present invention provides a system and method for dynamically controlling access to configuration attributes for a printing device. The method includes the operation of receiving a request for the printing device's configuration attributes at the printing device. The request is received from a requesting device. Another operation in determining a printing device's configuration attributes involves making a determination of configuration attributes supported by the printing device. Once the configuration attributes supported by the printing device are determined, markup language code associated with these configuration attributes can be identified. Further, the present invention includes the operation of transmitting the markup language code that is associated with the configuration attributes supported by the printing device to the requesting device.

### BRIEF DESCRIPTION OF THE DRAWINGS

FIG. 1 is a flow chart illustrating a method for dynamically controlling access to a printing device's configuration attributes according to an embodiment of the present invention;

FIG. 2 is a block diagram illustrating an embodiment of the invention for dynamically controlling access a printing device's configuration attributes;

FIG. 3 is a block diagram illustrating an embodiment of the invention for dynamically controlling access to a printing device's configuration attributes using an embedded web server;

FIG. 4 is a block diagram illustrating a system for dynamically controlling access to a printing device's configuration attributes over a network according to an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides one set of markup language code to describe the configuration attributes of multiple printing devices. For example, multiple models, series, or versions may have configuration attributes that are common to each device. The present invention can make a run-time determination of which markup language code corresponds to a particular printing device. According to one embodiment of the present invention, the markup language code is embedded in the printing device. At run-time, a program in the printing device determines which markup language code corresponds to configuration attributes supported by the device.

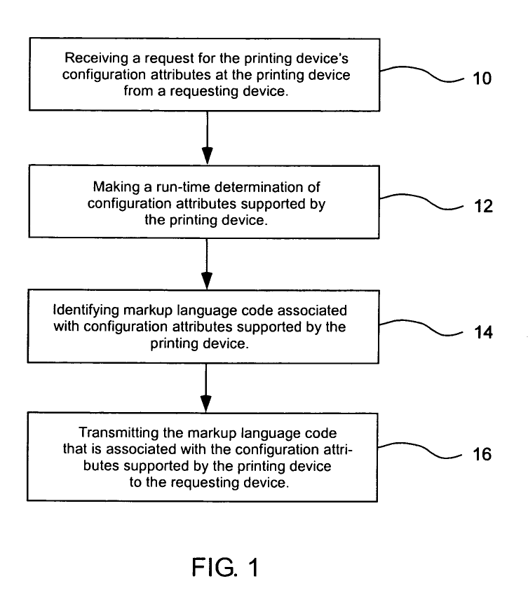

FIG. 1 illustrates a method for dynamically determining and displaying a printing device's configuration attributes. As shown in block 10, a request is received for the printing device's configuration attributes at the printing device. This request can be received from a requesting device such as a desktop computer, wireless PDA, wireless phone, and the originator of the request may be a user, network administrator, or software program on the requesting device. According to one embodiment of the present invention, the request is sent from a network browser and received in the printing device's embedded web server. In a different embodiment, instead of having an embedded web server, the printing device has an internal processor that receives the request through a communication port. The internal processor can be configured to receive the request from a network browser or from the device driver of the printing device.

Another operation included in the present invention is the operation of making a run-time determination of configuration attributes supported by the printing device, as shown in block 12. In order to effectively use the same set of markup language code in more than one distinct printing device, a run-time determination of supported configuration attributes can be made. Making a run-time determination refers to making a determination at any time after a build of the markup language code has been completed. For example, the run-time determination can be made when the markup language code is executed for the first time, when the printing device boots up, or when a request is made for the configuration attributes. The run-time determination can also be made when a hardware accessory is attached to the printing device or removed from the printing device. Run-time may more generally refer to any time the determination of configuration attributes is made that is not at design time or compile time.

After the run-time determination of configuration attributes is made, markup language code associated with the configuration attributes supported by the printing device is identified, as illustrated in block 14. According to one embodiment of the present invention, markup language code associated with an individual configuration attribute supported by the printing device is identified. For example, if a printing device supports printing on both sides of a page, the markup language, HTML page, and/or XML tree associated with this particular attribute is identified so that it can be transmitted to a user. Markup language code associated with groups of configuration attributes can also be identified. The markup language code associated with these groups can define a single markup language code document, multiple markup language code documents, or a portion of a single markup language code document.

The present invention also includes the operation of transmitting the markup language code that is associated with the configuration attributes supported by the printing device to the requesting device, as in block 16. When the printing device is accessed through a web browser, the printing device transmits markup language code that can be displayed in the browser. If the printing device's configuration attributes are accessed through device driver software on the external computer, the printing device transmits markup language code that can be displayed through the device driver software. In general terms, a device configuration interface can be generated to display the printing device's configuration attributes by including markup language code that is associated with the configuration attributes supported by the printing devices. For example, HTML code can be combined with database information about the printing device's configuration attributes to create an active user interface.

Having a set of markup language code that describes the configuration attributes of multiple printing devices is valuable because it eliminates the need to develop and build a new set of markup language code for each unique device. Taking this approach alone is not enough, because problems can arise in a device containing markup language code that refers to configuration attributes not supported by the device. Without the features of the present invention, this problem would lead to confusion on the part of the user and possible errors in communication with the printer. Determining which markup language code corresponds to the particular device overcomes this problem and helps reduce engineering workload and cost involved in developing a printing device.

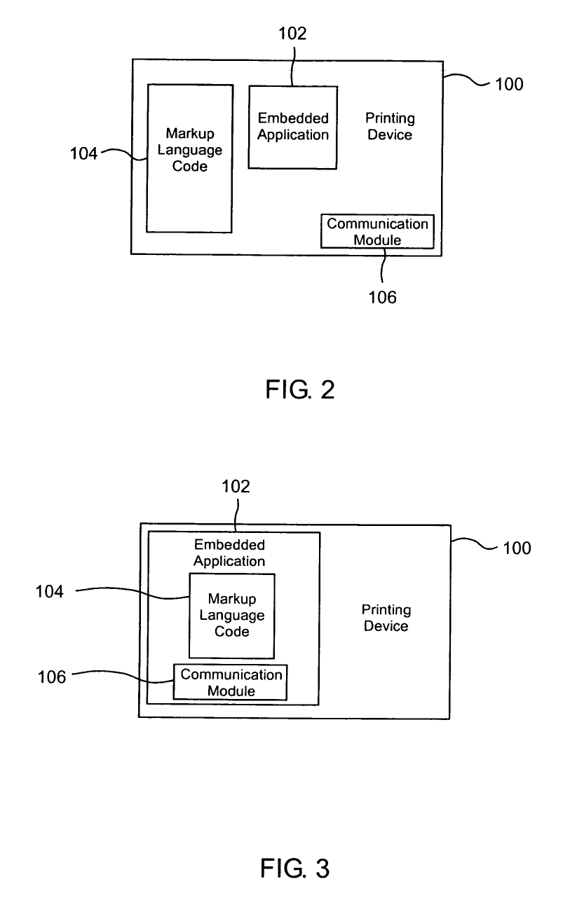

FIG. 2 illustrates a printing device 100 according to an embodiment of the present invention. Printing devices can include laser printers, ink jet printers, hot ink, or wax transfer printers, printer/fax/copier machines, copy machines, mobile printers, photo printers, large format plotters, multi-function printers, and similar digital publishing solutions.

The printing device 100 contains a communication module 106. The communication module 106 can include a parallel port, an Ethernet port, a modem, a serial connection, a USB port, a Firewire port, or any other communication system or protocol that couples a printing device to an external computer. Also, included in the printing device is a set of markup language code 104. This markup language code 104 can be used to help define documents using labels that are embedded within the code. These labels are typically known as “tags” and are used to control formatting, link pages together, and distinguish individual elements or groups of elements for display or user interface purposes.

Often, the printing device's configuration attributes are stored in sets of markup language code 104 that form documents such as hypertext markup language (HTML) pages or extensible markup language (XML) trees. The tags in HTML pages define the page layout, fonts, graphic elements and links to other HTML pages. The HTML pages may also contain forms or database controls that are the interfaces for the printing device's configuration attributes.

XML trees can be used for defining data elements on a Web page or other network documents. XML uses a tag structure similar to the structure used in HTML, and defines what data the tagged elements contain. Thus, virtually any data structure can be described by XML and this makes it useful in describing data sets like a printing device's configuration attributes. If the information is stored in an XML tree, the XML tree can be parsed and used to create an HTML page that displays the printing device's configuration attributes. HTML and XML are presented here in conjunction with one embodiment of the present invention. However, the present invention can be implemented with HTML, XML, standard generalized markup language (SGML), extensible hypertext markup language (XHTML), or any other markup language.

The markup language code 104 describes the configuration supported by the printing device. Configuration attributes include the settings, options, properties, and other configuration data that are supported by the printing device. Settings include output settings, color management, banner settings, and other printing device settings. There are numerous other options and properties included in printing devices such as print quality, pages per sheet, form feed, watermarks, and paper handling options. Current status and alert information also includes whether a sorting tray is connected to the printer, the amount of ink remaining in an ink cartridge, the printing device's busy status, and any other information that describes the present state of the printing device.

Some printing devices support different configuration attributes than other printing devices. For example, one printing device may support printer control language (PCL) while another printing device does not. If the markup language code that corresponds to PCL options and settings is included by default, then a printing device that does not support PCL can exclude this markup language code at run time. On the other hand, if the markup language code associated with PCL is excluded by default, the printing device that supports PCL would include this markup language code at run time. Excluding markup language code prevents a user from accessing the markup language code, but including markup language code provides a user with access to the code and printing device's configuration attributes.

Several different mechanisms are available for including or excluding markup language code at run time. One method is that the links to the unsupported markup language code can be disabled. In another method, logic can be embedded in the HTML or XML pages to include or exclude markup language code. Alternatively, the printing device can simply prohibit the transmission of unsupported markup language code. Another option is to include Meta commands in the markup language code. In HTML, Meta commands allow an embedded web server to change the contents of HTML pages dynamically. The Meta command is embedded in an HTML comment, and the updated information is inserted in place of the command as the page is loaded. For example, if the page includes an HTML file that might change, the Meta command ‘#include’ could be used in this manner: ‘<!-#include file=“pcl_Settings.htm”->.’ When the embedded web server parses the comments, it can search for the Meta commands. The embedded web server can then replace this comment line with the information from the specified file. Data returned from the specified file can be formatted using HTML, and the page can be designed to display the information.

According to one embodiment of the present invention in FIG. 2, the embedded application 102 and the communication module 106 include a network port. In a different embodiment, the embedded application is an internal processing system and the communication port is a parallel or serial port. The embedded application, the communication module, and the markup language code 104 may be integrated into the printing device at the time the printing device is manufactured.

FIG. 3 shows a printing device similar to the device shown in FIG. 2. In this printing device 100, the embedded application 102 includes the markup language code 104 and the communication module 106. This may be the case when the embedded application and communication module are part of an embedded web server.

The embedded web server can send markup language code to an external computer using Transport Control Protocol/Internet Protocol (TCP/IP). TCP/IP can successfully transfer data across all sizes and types of networks. Numerous data transfer protocols can move data over a TCP/IP network. Among these are File Transfer Protocol (FTP) and Hypertext Transfer Protocol (HTTP). HTTP is often used for communication between an embedded web server and an external computer. A browser on the external computer can send an HTTP request string to the embedded web server requesting a printing device's configuration attributes. When the embedded web server receives the HTTP request string, the embedded web server can locate and return the markup language code supported by the printing device.

Embedded web servers can provide markup language code that is formatted and displayed in HTML with any standard browser. The browser interprets and displays the configuration attribute data from the embedded web server in a manner that a user of an external computer can understand. Any known or available network browser, including Internet Explorer, Netscape Navigator®, Opera®, and numerous others, can be used to format and display the printing device's configuration attributes. The browser can also display options that allow a user's input to modify the device's configuration through the embedded web server.

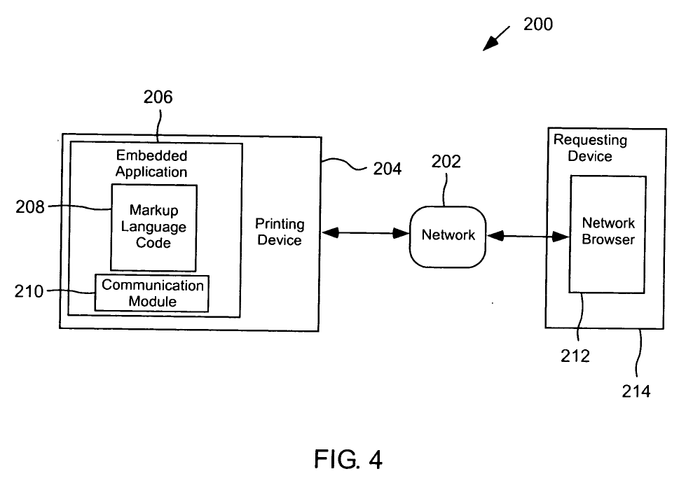

FIG. 4 is a representation of how communication works between a printing device 204 and a network browser 212. The network browser located in a requesting device 214 can send a request for the printing device configuration data over a network 202. The request is received through the communication module 210 at the printing device 204.

The network 202 used for connecting the embedded web server to an external computer can be a wireless network, a local area network, a wide area network, the Internet, or any other networking scheme. Wide area networks are networks that cover larger geographical areas, while local area networks usually refer to smaller networks contained within a building or complex. When a printing device with an embedded web server is connected to a network, any computer or network browser on the same network can communicate with the printing device.

The embedded application 206 can determine if the markup language code 208 is associated with configuration attributes that are supported by the printing device. Then the markup language code associated with the supported attributes can be sent to the network browser using the communication module 210 and network 202.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

1. A method for dynamically controlling access to configuration attributes for a printing device, comprising the steps of:
receiving a request for the printing device's configuration attributes at the printing device and the request is received from a requesting device;
making a determination of the configuration attributes supported by the printing device;
identifying markup language code associated with the configuration attributes supported by the printing device; and
transmitting the markup language code that is associated with the configuration attributes supported by the printing device, from the printing device to the requesting device.

2. A method as in claim 1, wherein the step of identifying markup language code further comprises the step of excluding markup language code that is associated with configuration attributes not supported by the printing device.

3. A method as in claim 1, wherein the step of identifying markup language code further comprises the step of identifying markup language code associated with groups of configuration attributes supported by the printing device.

4. A method as in claim 3, wherein the step of identifying markup language code further comprises the step of identifying groups of configurations attributes, wherein each group of configurations is associated with a markup language document.

5. A method as in claim 1, further comprising the steps of parsing an XML tree containing the printing device's configuration attributes and using the XML tree to create an HTML page that displays the printing device's configuration attributes.

6. A method as in claim 1, wherein the step of identifying markup language code further comprises the step of identifying markup language code associated with an individual configuration attribute supported by the printing device.

7. A method as in claim 1, wherein the step of receiving a request for the printing device's configuration attributes further comprises the step of receiving the request for the printing device's configuration attributes from a network browser into a printing device's embedded web server over a network.

8. A method as in claim 7, further comprising the step of using a local area network or the World Wide Web of the Internet as the network.

9. A method as in claim 1, further comprising the step of generating a device configuration interface to display the printing device's configuration attributes by including markup language code that is associated with the configuration attributes supported by the printing device.

10. A method as in claim 1, wherein the step of receiving a request for the printing device's configuration attributes further comprises the step of receiving a request for configuration attributes from a device driver for a printing device.

11. A system for dynamically determining configuration attributes for a printing device, comprising:
markup language code stored on the printing device, the markup language code being configured to describe and update the printing device's configuration attributes;
an embedded application in communication with the printing device, wherein the embedded application is configured to make a run-time determination of which markup language code corresponds to supported configuration attributes of the printing device; and
a communication module associated with the printing device, and the communication module is configured to receive requests for configuration attributes and transmit configuration attributes of the printing device.

12. A system as in claim 11, wherein the communication module is an embedded web server.

13. A system as in claim 11, wherein the printing device supports printer control language (PCL).

14. A system as in claim 11, wherein the markup language code includes HTML code.

15. A system as in claim 11, wherein the markup language code includes XML code.

16. A system for dynamically updating a printing device's configuration attributes, comprising:
a printing means for printing;
a markup language code means for describing configuration attributes, wherein the markup language code means is stored on the printing means;
an embedded application means stored in the printing means, wherein the embedded application means is for making a run-time determination of which markup language code corresponds to the configuration attributes supported by the printing means; and
a communication module means in the printing means, wherein the communication port means is for receiving requests for the configuration attributes and transmits configuration attributes supported by the device.

17. A system as in claim 16, wherein the communication module means is an embedded web server.

18. An article of manufacture, comprising:
a computer usable medium having computer readable program code embodied therein for dynamically controlling access to configuration attributes for a printing device, the computer readable program code means in the article of manufacture comprising:
computer readable program code for receiving a request for the printing device's configuration attributes;
computer readable program code for making a run-time determination of configuration attributes supported by the printing device;
computer readable program code for identifying markup language code associated with the configuration attributes supported by the printing device; and
computer readable program code for transmitting the markup language code that is associated with the configuration attributes supported by the printing device to the requesting device.
